(19) United States
(12) Patent Application Publication
(10) Pub. No.: US 2025/0313284 A1
(43) Pub. Date: Oct. 9, 2025

(54) VEHICLE SIDE STRUCTURE

(71) Applicant: TOYOTA JIDOSHA KABUSHIKI KAISHA, Toyota-shi (JP)

(72) Inventors: Katsuma HIGASHIKAWA, Toyota-shi (JP); Eiichi TAKEUCHI, Toyota-shi (JP); Shiyota UMEMOTO, Kariya-shi (JP); Juri ITO, Toyota-shi (JP); Masaaki WAKAHARA, Okazaki-shi (JP)

(73) Assignee: TOYOTA JIDOSHA KABUSHIKI KAISHA, Toyota-shi (JP)

(21) Appl. No.: 18/989,834

(22) Filed: Dec. 20, 2024

(30) Foreign Application Priority Data
Apr. 9, 2024 (JP) 2024-062933

(51) Int. Cl. B62D 37/02; B62D 35/00

(52) U.S. Cl. CPC B62D 37/02; B62D 35/00

(57) ABSTRACT

The vehicle side structure includes: a duct portion disposed forward in a vehicle front-rear direction of a tire and including an inlet port for introducing air when the vehicle is traveling and an outlet port for discharging the air when the vehicle is traveling; a rotation shaft extending in a vehicle width direction between the inlet port and the outlet port and connected to the duct portion; and a flow guide portion supported by the rotation shaft at a center of gravity of the flow guide portion and shaped in such a manner that a lower surface in a vehicle up-down direction of the flow guide portion speeds up a flow of the air more than an upper surface in the vehicle up-down direction of the flow guide portion.

### CROSS-REFERENCE TO RELATED APPLICATION

This application claims priority to Japanese Patent Application No. 2024-062933 filed on Apr. 9, 2024, incorporated herein by reference in its entirety.

### BACKGROUND

### 1. Technical Field

The present disclosure relates to vehicle side structures.

### 2. Description of Related Art

Japanese Unexamined Patent Application Publication No. 2014-076728 (JP 2014-076728 A) discloses a vehicle front structure in which air introduced from an inlet port is discharged from an outlet port along a side surface of a tire when a vehicle is traveling. This vehicle front structure generates an air curtain to reduce turbulence outside in a vehicle width direction of the tire, thereby reducing air resistance and improving stability of the vehicle.

It is also known to fix a stay (flow guide portion), namely a member that guides the air flow upwards, in a duct between the inlet and outlet ports in the structure of the related art in order to apply a downforce to the vehicle. This stay causes the front tire to be gripped to the road surface, so that road followability can be improved.

### SUMMARY

However, the stay fixed in the duct as in the related art has the following issue. When the wind direction changes in an up-down direction, unsteady vortices due to airflow separation occur at the lower surface of a distal end of the stay, causing fluctuations in downforce and fluctuations in flow velocity and direction after passage through the air curtain. This may reduce steering stability of the vehicle. Since such unsteady vortices occur, louder sound is generated in the duct and is radiated to the outside of the duct, which may reduce in-vehicle quietness. Therefore, there is room for improvement in improving in-vehicle quietness while maintaining steering stability of a vehicle.

In view of the above, it is an object of the present disclosure to provide a vehicle side structure that can improve in-vehicle quietness while maintaining steering stability of a vehicle.

A vehicle side structure of the disclosure of claim 1 includes:
a duct portion disposed forward in a vehicle front-rear direction of a tire and including an inlet port for introducing air when a vehicle is traveling and an outlet port for discharging the air when the vehicle is traveling;
a rotation shaft extending in a vehicle width direction between the inlet port and the outlet port and connected to the duct portion; and
a flow guide portion supported by the rotation shaft at a center of gravity of the flow guide portion and shaped in such a manner that a lower surface in a vehicle up-down direction of the flow guide portion speeds up a flow of the air more than an upper surface in the vehicle up-down direction of the flow guide portion.

According to the disclosure of claim 1, when the vehicle is traveling, air is introduced from the inlet port and discharged from the outlet port in the duct portion disposed forward in the vehicle front-rear direction of the vehicle. An air curtain is thus generated outside in the vehicle width direction of the tire, so that turbulence and air resistance are reduced.

The flow guide portion disposed between the inlet port and the outlet port in the duct portion is shaped in such a manner that the lower surface in the vehicle up-down direction of the flow guide portion speeds up the flow of the air more than the upper surface in the vehicle up-down direction of the flow guide portion. The air flow passing through the duct portion is thus guided upward in the vehicle up-down direction, and a downward force (downforce) acts on the vehicle. As a result, the tire is gripped to the road surface, so that road followability can be improved.

Moreover, the flow guide portion is supported by the rotation shaft extending in the vehicle width direction and connected to the duct portion. The flow guide portion is supported at its center of gravity by the rotation shaft. Therefore, the flow guide portion rotates about the rotation shaft according to the direction of the air flow passing through the duct portion, and stabilizes in a state in which a downward pressure applied to the upper surface in the vehicle up-down direction of the flow guide portion and an upward pressure applied to the lower surface in the vehicle up-down direction of the flow guide portion are balanced. This reduces both unsteady vortices due to air separation and noise due to turbulence, regardless of whether the wind direction changes in the up-down direction.

According to a vehicle side structure of the disclosure of claim 2, in the disclosure of claim 1,
the vehicle side structure may further include a rotation restricting portion that restricts rotation of the flow guide portion to a predetermined angle range.

According to the disclosure of claim 2, the rotation of the flow guide portion is restricted to the predetermined angle range by the rotation restricting portion. The flow guide portion is therefore less likely to continuously rotate vigorously when the vehicle starts to travel or when the wind direction changes. Accordingly, the flow guide portion can quickly take a stable attitude according to the wind direction.

According to a vehicle side structure of the disclosure of claim 3, in the disclosure of claim 2,
the duct portion may include a duct inner wall to which an inner end in the vehicle width direction of the rotation shaft is connected, and a duct outer wall to which an outer end in the vehicle width direction of the rotation shaft is connected, and
the rotation restricting portion may include a guide slit and a guide portion. The guide slit may extend through either or both of the duct inner wall and the duct outer wall in the vehicle width direction and having an arc shape about the rotation shaft as viewed in the vehicle width direction. The guide portion may protrude outward in the vehicle width direction from a side surface in the vehicle width direction of the flow guide portion, and may be inserted through the guide slit so as to be movable in the guide slit.

According to the disclosure of claim 3, either or both of the duct inner wall and the duct outer wall has the guide slit. The guide slit extends through either or both of the duct inner wall and the duct outer wall in the vehicle width direction, and has an arc shape about the rotation shaft. The guide portion protrudes outward in the vehicle width direction from the side surface in the vehicle width direction of the flow guide portion. The guide portion is inserted through the guide slit. Therefore, when the flow guide portion rotates about the rotation shaft, the guide portion moves along the guide slit, and the rotation of the flow guide portion is restricted by an end of the guide slit.

According to a vehicle side structure of the disclosure of claim 4, in the disclosure of claim 3,
the guide portion may have an arc shape about the rotation shaft as viewed in the vehicle width direction and may have a smaller central angle than the guide slit.

According to the disclosure of claim 4, the guide portion having the arc shape moves along the guide slit having the arc shape. This reduces rattling of the guide portion with respect to the guide slit.

According to a vehicle side structure of the disclosure of claim 5, in the disclosure of any one of claims 1 to 4, the flow guide portion may be hollow and may have an opening.

According to the disclosure of claim 5, the flow guide portion is hollow, and the spaces inside and outside the flow guide portion communicate with each other via the opening. The flow guide portion thus functions as a resonance silencer (resonator). That is, it is possible to reduce air flow noise amplified through the duct portion.

As described above, the vehicle side structure of the disclosure of claim 1 is highly advantageous in that it can improve in-vehicle quietness while maintaining steering stability of the vehicle.

The vehicle side structure of the disclosure of claim 2 is highly advantageous in that it can quickly improve road followability.

The vehicle side structure of the disclosure of claim 3 is highly advantageous in that it restricts rotation of the flow guide portion by a simple configuration.

The vehicle side structure of the disclosure of claim 4 is highly advantageous in that it can further improve the steering stability of the vehicle and the in-vehicle quietness.

The vehicle side structure of the disclosure of claim 5 is highly advantageous in that it can further improve the in-vehicle quietness.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a front portion of a vehicle to which a vehicle side structure according to the present embodiment is applied as viewed from a left front side;

FIG. 2 is an enlarged perspective view of a main part of the structure of the front wheel shown in FIG. 1 in an exploded manner;

FIG. 3 is a longitudinal sectional view of the stay shown in FIG. 2 as viewed in the vehicle width direction;

FIG. 4 is a side view showing a state in which, when an obliquely downward wind flows into the duct portion, the stay shown in FIG. 2 is rotated in a direction to be tilted toward the vehicle front side and the rotation is restricted;

FIG. 5 is a side view showing a state in which the flow of the upper surface of the stay shown in FIG. 4 pushes down the vehicle rear side of the stay;

FIG. 6 is a side elevational view of the top and bottom surfaces of the stay shown in FIG. 5 in a pressure balanced condition; and

FIG. 7 is a diagram illustrating a shape of a stay according to a modification.

### DETAILED DESCRIPTION OF EMBODIMENTS

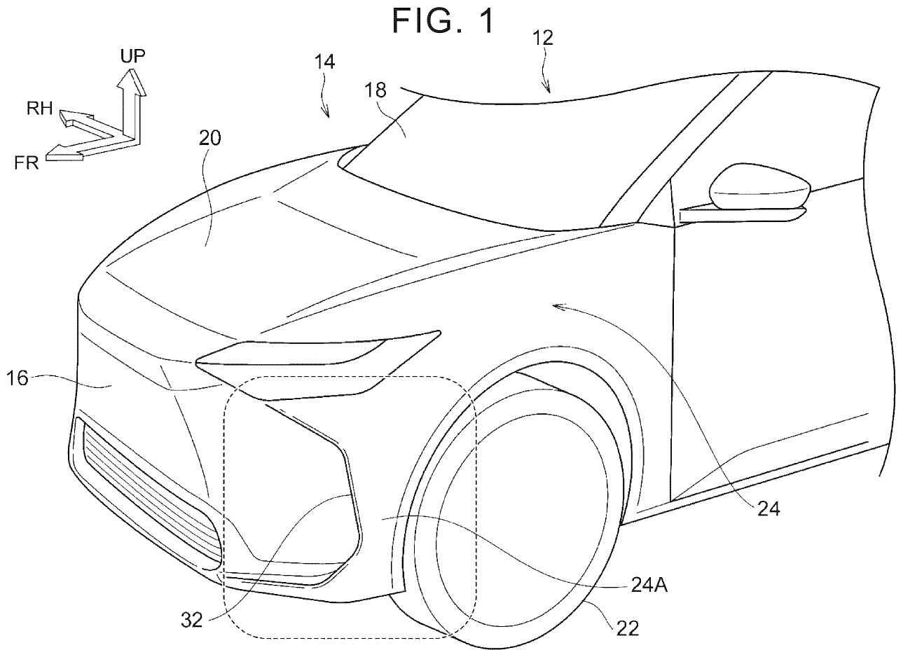

Hereinafter, a vehicle 12 to which a vehicle side structure according to an embodiment of the present disclosure is applied will be described with reference to FIGS. 1 to 6. The arrow FR, the arrow UP, and the arrow LH shown in the drawings indicate the front side, the upper side, and the left side in the left-right direction (widthwise direction) of the vehicle 12, respectively. In addition, in the following description, when the front, rear, up, down, and left and right directions are used without special mention, the front and rear directions in the vehicle front-rear direction, the up and down directions in the vehicle up-down direction, and the left and right directions (width directions) in the vehicle left-right direction are respectively indicated.

FIG. 1 is a perspective view of a front portion 14 of a vehicle 12 to which a vehicle side structure according to the present embodiment is applied as viewed from a left front side. Since the vehicle 12 is configured to be symmetrical, the side structure on the left side of the vehicle will be mainly described in the following description, and the description of the side structure on the right side of the vehicle will be omitted.

The front portion 14 of the vehicle 12 includes a front bumper 16, an engine hood 20, a front wheel 22 as a tire, and a fender panel 24 disposed so as to cover the front, upper, and rear sides in the vehicle front-rear direction and vehicle up-down direction of the front wheel 22. The front bumper 16 constitutes the front surface of the vehicle 12. The engine hood 20 is disposed forward in the vehicle front-rear direction of the front windshield 18 and constitutes an upper surface of an engine compartment.

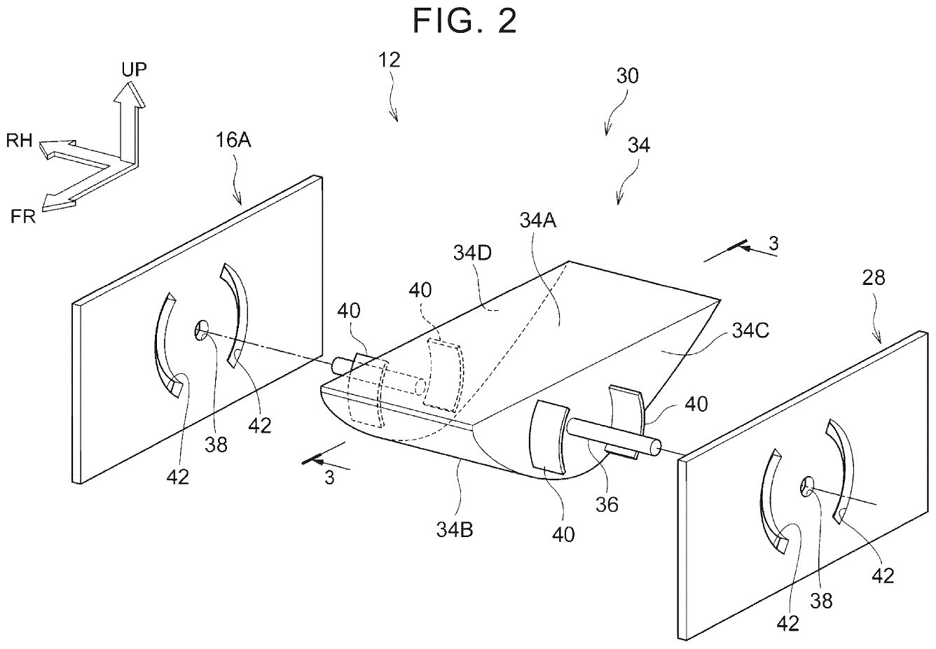

In the fender panel 24, the fender front portion 24A includes a fender outer panel 26 and a fender inner panel 28 (see FIG. 2) positioned on the vehicle width direction inner side of the fender outer panel 26. The fender front portion 24A is located forward in the vehicle front-rear direction of the front wheel 22. The fender outer panel 26 is located outside in the vehicle width direction.

The left end 16A of the front bumper 16 (see FIG. 2) extends to the vehicle front side of the front wheel 22 so as to face the fender inner panel 28 in the vehicle width direction. In other words, the fender inner panel 28 is disposed at a predetermined distance in the vehicle width direction with respect to the left end 16A of the front bumper 16. As a result, a passage passing through the vehicle front-rear direction is formed between the fender inner panel 28 and the left end 16A of the front bumper 16, and the duct portion 30 is formed. The left end 16A of the front bumper 16 in the present embodiment corresponds to the duct inner wall in the present disclosure, and the fender inner panel 28 in the present embodiment corresponds to the duct outer wall in the present disclosure.

The duct portion 30 includes a fender inner panel 28 and a left end 16A of the front bumper 16. Further, the duct portion 30 includes an inlet port 32 for introducing air from the front side of the vehicle when the vehicle 12 is traveling, and an outlet port (not shown) for discharging the air toward the rear of the vehicle. During traveling of the vehicle 12, an air curtain is generated on the vehicle width direction outer side of the front wheel 22 by the traveling wind flowing out from the outflow port.

As shown in FIG. 2, a stay 34 is provided between the fender inner panel 28 and the left end 16A of the front bumper 16, and between the inlet port (see FIG. 1) and the outlet port (not shown) as a flow guide portion for guiding the flow of air passing through the duct. The stay 34 is supported at its center of gravity by a rotation shaft 36 extending in the vehicle width direction. An outer side of the rotation shaft 36 in the vehicle width direction is connected to the fender inner panel 28. Further, the vehicle width direction inner side of the rotation shaft 36 is connected to the left end 16A of the front bumper 16. In FIG. 2, only a part of the fender inner panel 28 and the front bumper 16 is illustrated for convenience of explanation.

The stay 34 has the same cross-sectional shape over substantially the entire area in the vehicle width direction. The upper surface 34A of the stay 34 is a flat surface. On the other hand, the lower surface 34B of the stay 34 is curved so as to be concave downward in the vehicle up-down direction as viewed in the vehicle widthwise direction. More specifically, the lower surface 34B of the stay 34 is shaped to include a cycloidal curve at the front portion when viewed from the vehicle width direction. As a result, the lower surface 34B of the stay 34 speeds up the air flow more than the upper surface 34A. The rear portion of the lower surface 34B of the stay 34 is formed to be more gently curved than the front portion.

The fender inner panel 28 is formed with a shaft insertion hole 38 penetrating in the plate thickness direction. An end of the rotation shaft 36 on the outer side in the vehicle width direction is inserted into the shaft insertion hole 38. Thus, an end of the rotation shaft 36 on the outer side in the vehicle width direction is supported by the fender inner panel 28.

Further, a shaft insertion hole 38 is formed in the left end 16A of the front bumper 16. An end of the rotation shaft 36 on the vehicle width direction inner side is inserted into the shaft insertion hole 38. Thus, an end of the rotation shaft 36 on the inner side in the vehicle width direction is supported by the fender inner panel 28.

A pair of front and rear guide portions 40 is provided on the left side surface 34C and the right side surface 34D of the stay 34, respectively. Further, the fender inner panel 28 is formed with a pair of front and rear guide slits 42 through which a pair of front and rear guide portions 40 provided on the left side surface 34C of the stay 34 are respectively inserted. Further, a pair of front and rear guide slits 42 through which a pair of front and rear guide portions 40 provided on the right side surface 34D of the stay 34 are respectively inserted are formed on the left end 16A of the front bumper 16.

The pair of front and rear guide portions 40 and the pair of front and rear guide slits 42 are provided symmetrically. Therefore, in the following description, the left guide portion 40 and the guide slit 42 will be described, and the description of the right guide portion 40 and the guide slit 42 will be omitted.

Each of the pair of front and rear guide slits 42 is formed to penetrate in the thickness direction of the fender inner panel 28. Further, the pair of front and rear guide slits 42 are each formed in a long hole shape curved in an arc shape centered on the shaft insertion hole 38 when viewed from the vehicle width direction.

The pair of front and rear guide portions 40 are formed to protrude outward in the vehicle width direction from the left side surface 34C of the stay 34. The front guide portion 40 is inserted into the front guide slit 42. Further, the rear guide portion 40 is inserted into the rear guide slit 42.

Further, the pair of front and rear guide portions 40 are each formed in an arcuate elongated hole shape about the rotation shaft 36 as viewed in the vehicle width direction and has a smaller central angle than the guide slit 42. Thus, the guide portion 40 of the front side is movable within a predetermined angle range in the circumferential direction of the arc in the guide slit 42 of the front side, the guide portion 40 of the rear side is movable within a predetermined angle range in the circumferential direction of the arc in the guide slit 42 of the rear side. In other words, the rotation of the stay 34 is restricted to a predetermined angle range by the pair of front and rear guide portions 40 and the pair of front and rear guide slit 42. The pair of front and rear guide portions 40 and the pair of front and rear guide slits 42 in the present embodiment correspond to the rotation restricting portion in the present disclosure.

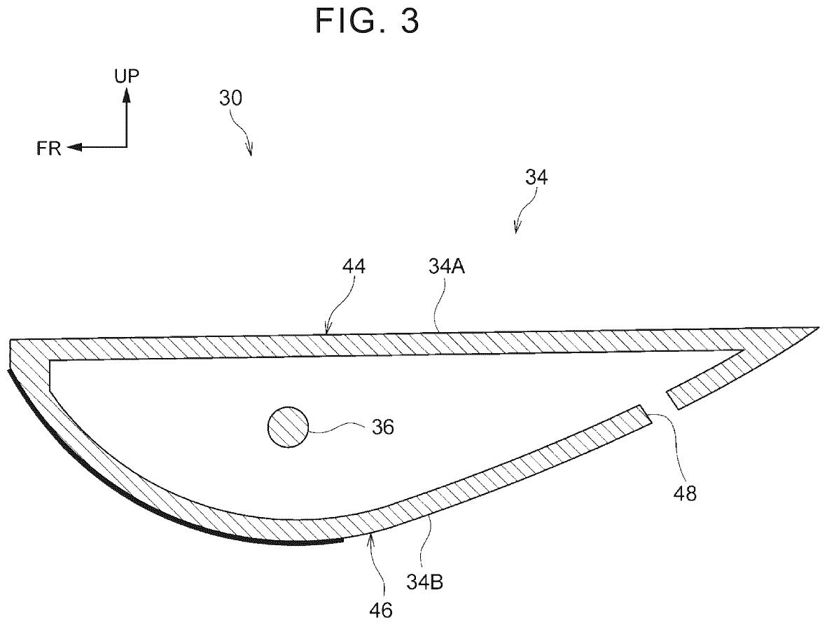

As shown in FIG. 3, the stay 34 includes an upper wall portion 44 and a lower wall portion 46 and is hollow. A slit 48 as an opening extending in the vehicle width direction is formed in a rear portion of the lower wall portion 46 of the stay 34. As described above, the stay 34 has a resonator structure capable of suppressing noise generated in the space in the duct.

### Operations

Next, operations of the embodiment will be described.

According to the vehicle side structure of the present embodiment, when the vehicle 12 is traveling, air is introduced from the inlet port 32 and discharged from the outlet port (not shown) in the duct portion 30 disposed forward in the vehicle front-rear direction of the front wheel 22. As a result, an air curtain is generated on the vehicle width direction outer side of the front wheel 22, and the turbulence is suppressed and the air resistance is reduced.

In addition, the stay 34 is shaped such that the lower surface 34B speeds up the air flow more than the upper surface 34A. As a result, the air flow through the duct portion 30 is guided upward in the vehicle up-down direction, and a downward force (downforce) acts on the vehicle 12. Therefore, the front wheels 22 are gripped to the road surface, and the road followability can be improved.

Further, the stay 34 is supported at its center of gravity by the rotation shaft 36. Thus, the stay 34 is rotated about the rotation shaft 36 in accordance with the direction of the airflow passing through the duct portion 30, the downward pressure received by the upper surface 34A and the upward pressure received by the lower surface 34B are stabilized in balance. Therefore, the generation of unsteady vortices due to separation and the noise caused by turbulence are suppressed regardless of the vertical change of the wind direction.

Further, according to the vehicle side structure of the present embodiment, the rotation of the stay 34 is restricted to a predetermined angle range by the pair of front and rear guide portions 40 and the pair of front and rear guide slits 42. Thus, with a simple configuration, the stay 34 is prevented from rotating continuously vigorously due to the start of traveling of the vehicle 12 or a change in the wind direction. Therefore, the stay 34 can quickly assume a stable posture in accordance with the wind direction.

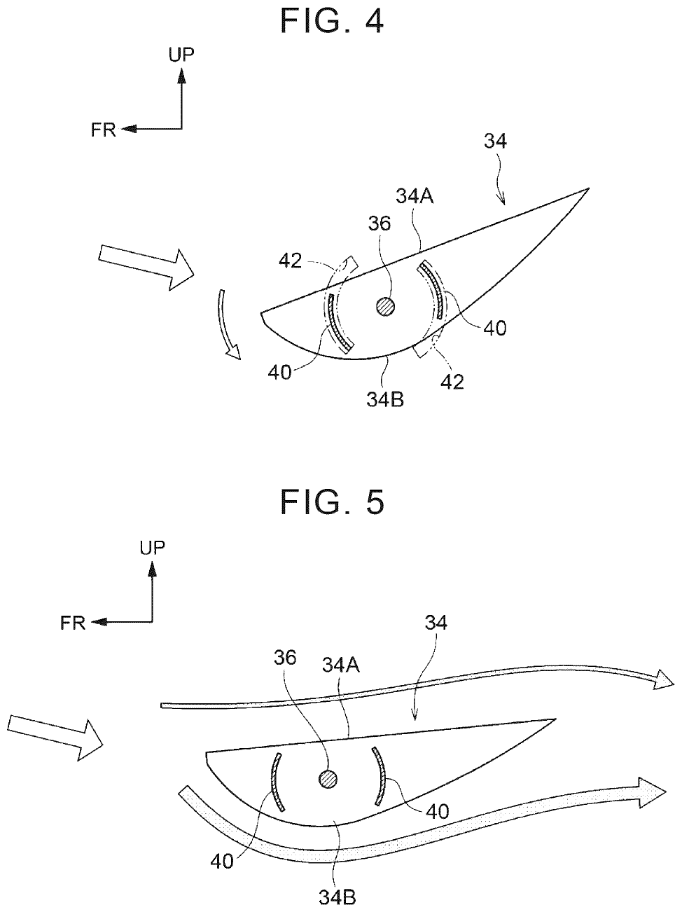

Here, with reference to FIGS. 4 to 6, the state change from the wind direction changes until the stay 34 assumes a stable posture will be described in detail.

As shown in FIG. 4, for example, when the wind direction changes and the obliquely downward wind flows into the duct portion 30, the stay 34 is vigorously rotated in such a direction that the stay 34 is tilted forward in the vehicle front-rear direction. At this time, the lower end of the front guide portion 40 abuts against the lower end of the front guide slit 42, and at the same time, the upper end of the rear guide portion 40 abuts against the upper end of the rear guide slit 42. Thus, the rotation of the stay 34 is restricted.

Here, as shown in FIG. 5, the rear end of the stay 34 is pushed down by the difference between the pressure applied to the upper surface 34A and the pressure applied to the lower surface 34B.

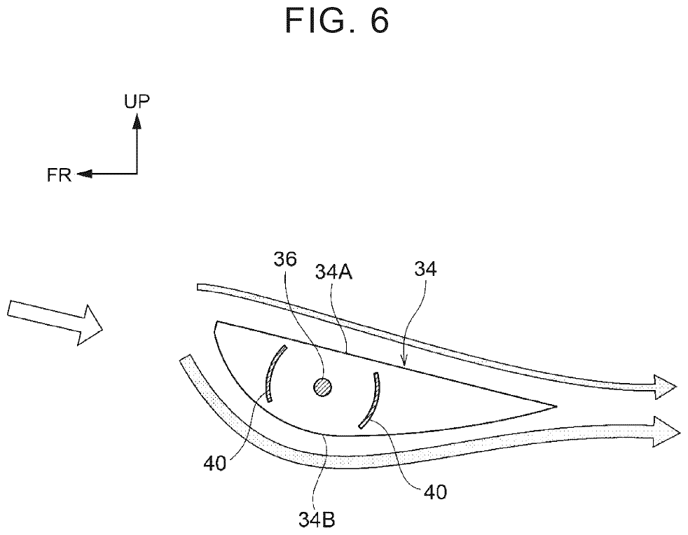

Then, as shown in FIG. 6, the stay 34 assumes a stable posture while the pressure applied to the upper surface 34A and the pressure applied to the lower surface 34B are balanced. At this time, since the front portion of the lower surface 34B is shaped to include a cycloidal curve, an obliquely forward downward force acts on the rotation shaft 36 at the maximum flow velocity point. As a result, the downforce is applied to the vehicle 12, and the road followability is improved.

Note that, although not shown, for example, when the wind direction changes and the obliquely upward wind flows into the duct portion 30, the stay 34 is vigorously rotated in the direction of falling toward the vehicle rear side, and the rotation is restricted by the rotation restricting portion. Then, the rear end of the stay 34 is pushed up by the difference between the pressure applied to the upper surface 34A and the pressure applied to the lower surface 34B, and the stay 34 assumes a stable posture while the pressure applied to the upper surface 34A and the pressure applied to the lower surface 34B are balanced.

Further, according to the vehicle side structure of the present embodiment, the guide portion 40 formed in an arc shape moves along the guide slit 42 formed in an arc shape. This reduces rattling of the guide portion 40 with respect to the guide slit 42.

Furthermore, according to the vehicle side structure of the present embodiment, the stay 34 is hollow, and the spaces inside and outside the stay 34 communicate with each other via the slit 48. As a result, the stay 34 functions as a resonant muffler (resonator). That is, it is possible to reduce the airflow noise amplified through the duct portion.

### Supplementary Explanation of Embodiment

In the above embodiment, the duct portion 30 is described as being disposed forward in the vehicle front-rear direction of the front wheel 22, but the present disclosure is not limited thereto, and the duct portion may be disposed forward in the vehicle front-rear direction of the rear wheel.

Further, in the above embodiment, the vehicle side structure has been described as having a pair of front and rear guide portions 40 and a pair of front and rear guide slits 42 for restricting the rotation of the stay 34 to a predetermined angle range, but the present disclosure is not limited thereto. For example, the guide portion and the guide slit may be only one side as well as a pair. In addition, the number of the rotation restricting portions may be any number or may be arranged asymmetrically. Further, for example, the guide portion is not limited to an arcuate elongated hole shape, and may be formed in a circular shape having a diameter substantially the same as the width of the guide slit as viewed in the vehicle width direction. The rotation restricting portion is not limited to the configuration of the guide portion and the guide slit, and may be any structure that restricts the rotation of the flow guide portion.

Furthermore, in the above embodiment, the stay 34 is hollow and has the slit 48, but the present disclosure is not limited thereto, and the flow guide portion may be solid.

Furthermore, in the above embodiment, the description has been given assuming that one stay 34 is disposed in the duct, but the present disclosure is not limited thereto, and a plurality of flow guide portions may be disposed in the duct. For example, a plurality of stays may be arranged side by side in the vertical direction.

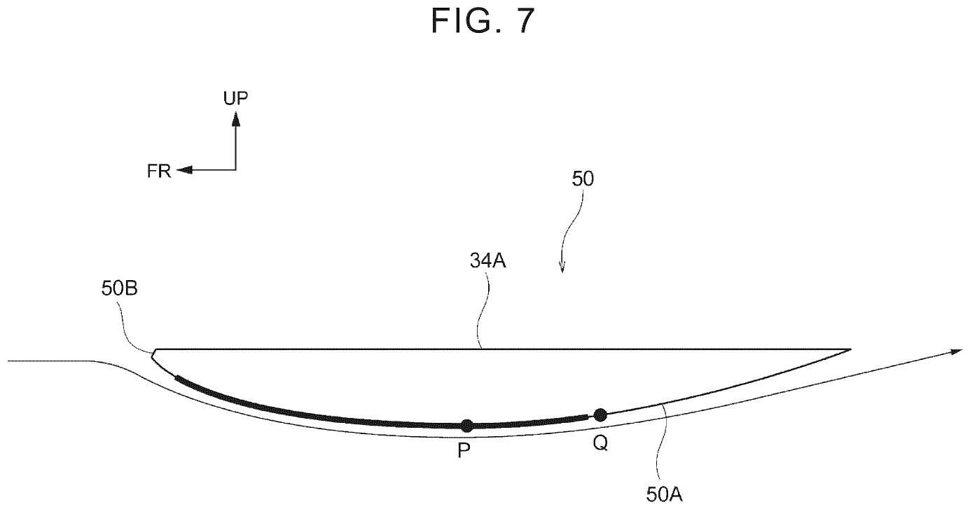

In the above-described embodiment, the upper surface 34A of the stay 34 is a flat surface, and the lower surface 34B of the stay 34 is shaped to include a cycloidal curve at the front portion when viewed from the vehicle width direction. However, the present disclosure is not limited thereto. For example, the shape of the stay 50 according to the modification shown in FIG. 7 may be adopted. In the following modification examples, the same components as those of the embodiment are denoted by the same reference numerals, and description thereof will be omitted as appropriate.

### Modifications

As shown in FIG. 7, the stay 50 as the flow guide portion of the vehicle side structure according to the modification has a laminar airfoil cross section. The laminar airfoil cross section is a shape in which the point P at which the bulge of the lower surface 50A is maximized is located at 40 to 50% from the front end 50B of the stay 50 and is located behind the bulge maximal point of the stay having a typical airfoil cross section. As a result, the turbulence transition point Q is located closer to the rear side of the vehicle than the turbulence transition point of the stay having a typical blade cross section, so that the airflow along the lower surface 50A can be kept in a laminar flow condition for a long time. That is, since the laminar flow region (a portion indicated by a thick line in FIG. 7) increases and the turbulence region decreases, the air resistance can be reduced as compared with a stay having a one-end blade cross section.

What is claimed is:

1. A vehicle side structure comprising:
a duct portion disposed forward in a vehicle front-rear direction of a tire and including an inlet port for introducing air when a vehicle is traveling and an outlet port for discharging the air when the vehicle is traveling;
a rotation shaft extending in a vehicle width direction between the inlet port and the outlet port and connected to the duct portion; and
a flow guide portion supported by the rotation shaft at a center of gravity of the flow guide portion and shaped in such a manner that a lower surface in a vehicle up-down direction of the flow guide portion speeds up a flow of the air more than an upper surface in the vehicle up-down direction of the flow guide portion.

2. The vehicle side structure according to claim 1, further comprising a rotation restricting portion that restricts rotation of the flow guide portion to a predetermined angle range.

3. The vehicle side structure according to claim 2, wherein:
the duct portion includes a duct inner wall to which an inner end in the vehicle width direction of the rotation shaft is connected, and a duct outer wall to which an outer end in the vehicle width direction of the rotation shaft is connected; and
the rotation restricting portion includes a guide slit and a guide portion, the guide slit extending through either or both of the duct inner wall and the duct outer wall in the vehicle width direction and having an arc shape about the rotation shaft as viewed in the vehicle width direction, and the guide portion protruding outward in the vehicle width direction from a side surface in the vehicle width direction of the flow guide portion and inserted through the guide slit so as to be movable in the guide slit.

4. The vehicle side structure according to claim 3, wherein the guide portion has an arc shape about the rotation shaft as viewed in the vehicle width direction and has a smaller central angle than the guide slit.

5. The vehicle side structure according to any one of claim 1, wherein the flow guide portion is hollow and has an opening.
